(19) United States
(12) Patent Application Publication
(10) Pub. No.: US 2002/0068489 A1
(43) Pub. Date: Jun. 6, 2002

(54) Electrical contact in substrate recess

(76) Inventor: Woody Wurster, Washoe Valley, NV (US)

Correspondence Address: LEON D. ROSEN, FREILICH, HORNBAKER & ROSEN, Suite 1220, 10960 Wilshire Blvd., Los Angeles, CA, 90024, US

(21) Appl. No.: 09/729,358

(22) Filed: Dec. 4, 2000

(51) Int. Cl. H01R 9/24

(52) U.S. Cl. 439/884

(57) ABSTRACT

A contact assembly which includes a silver billet (14) locked in a recess (22) of a copper alloy substrate (12), is constructed so it can be formed in a minimum number of low cost operations. Depressions (70) in the upper face (32) of the substrate, create pressure-flowed quantities (72, 74) of the substrate metal that project into opposite sides (54, 56) of the billet to lock the billet in the recess. The depressions preferably form a continuous 360° groove to form a gas tight seal. The groove has a wall (80) closest to the recess, with that wall extending downward and away from the recess, as a result of a punch (50) that presses downwardly into the upper surface of the substrate and deforms substrate material towards the recess. The billet can be pressed down with sufficient force to expand the billet tight against opposite recess walls.

### BACKGROUND OF THE INVENTION

Low cost contacts are provided by inserting billets of good contact material such as silver into a substrate such as copper. The billet generally has high conductivity and corrosion and/or wear resistance while the substrate is of low cost. Techniques for locking such a billet in the substrate have generally involved a plurality of steps to form the billet-receiving hole and a plurality of steps to lock the billet in the hole. A method that resulted in a minimum number of steps to install and lock the billet in the substrate hole, would be of value. The resulting contact assembly which could be constructed at low cost, while providing secure mounting of the billet, would also be of value.

### SUMMARY OF THE INVENTION

In accordance with one embodiment of the present invention, a contact assembly and method for manufacturing it are provided, wherein a metal billet is locked in a recess in the upper face of a substrate, which enables fabrication with a minimum number of steps so the resulting contact assembly is of low cost. The substrate has depressions close to opposite sides of the billet-holding recess. The depressions create a pressure-flowed quantity of substrate metal at each side, that projects into and deforms the billet side to lock the billet in the recess.

Each depression has a side wall nearest the recess, which extends at a downward incline in a direction away from the recess. Such depression wall displaces substrate metal partially horizontally towards the billet as the depression is formed by a downwardly-moving punch. The displaced substrate metal moves into a side of the billet to lock the billet in the substrate. The depressions in the substrate are preferably part of a continuous groove that extends 360° around the billet to form a fluid-tight seal between the walls of the recess and the billet. The recess is preferably a blind hole with the substrate forming a bottom wall of the recess, so the entire volume of the recess below the location where substrate material has deformed into the billet, is made fluid tight.

The process for forming the contact assembly includes pressing a first punch downwardly into the upper face of the substrate and pulling out the first punch to leave a recess. A next step is to cut the billet from a continuous strip and move down the billet into the recess. A next possible step is to press down the billet with a pressure pad. The pressure pad can press with sufficient force to expand the billet so it abuts the inner walls of the recess. A fourth step is to move a second punch against a surface of the substrate near the recess, as by moving down the second punch against the upper surface of the substrate at an area immediately around the recess. As the second punch moves down into the substrate, a side of the second punch closest to the recess displaces substrate material towards the recess. That substrate material moves into sides, or perimeter, of the billet. The result is a substrate recess with an undercut portion and a billet with a partially upwardly-facing shoulder under the undercut, that prevents upward pullout of the billet. Where the first punch forms only a blind recess, only a moderate force is required to push it down. The second punch moves down by no more than the height of the recess, so it can be moved down with only a moderate force. This permits construction of the contact assembly using a press of moderate capacity.

The novel features of the invention are set forth with particularity in the appended claims. The invention will be best understood from the following description when read in conjunction with the accompanying drawings.

### BRIEF DESCRIPTION OF THE DRAWINGS

FIG. 1 is a top isometric view of a contact assembly of a first embodiment of the invention, and showing, in phantom lines, a billet prior to its movement down into the substrate recess.

FIG. 2 is a sectional side view of the contact assembly of FIG. 1, after the recess has been formed.

FIG. 3 is a view similar to FIG. 2, but after the billet is lowered into the recess.

FIG. 3A is a view similar to FIG. 3, but during a possible next step while fully pressing the billet into the recess to hold it in place.

FIG. 4 is a view similar to FIG. 3, but showing the second punch as it is moved down into the substrate to lock the billet in the substrate.

FIG. 5 is an enlarged view of opposite sides of the contact assembly of FIG. 4, after the second punch has been removed, with FIG. 5 showing the final contact assembly.

FIG. 6 is a partial sectional view of the contact assembly of FIG. 3, showing the manner in which the billet is severed from a strip and moved down into the substrate recess.

FIG. 7 is a plan view of the contact assembly of FIG. 1.

FIG. 8 is a sectional side view of a contact assembly of another embodiment of the invention, and showing how punches are applied to lock the billet in the substrate.

FIG. 9 is a sectional side view of a contact assembly of another embodiment of the invention, and showing how punches are applied to lock the billet in the substrate.

FIG. 10 is a sectional side view of a contact assembly of another embodiment of the invention, where the substrate initially is a plate.

### DESCRIPTION OF THE PREFERRED EMBODIMENTS

FIG. 1 illustrates a contact assembly 10 which includes a metal substrate 12 and a metal billet 14 installed in the substrate. FIG. 1 also shows the shape of the billet at 14A prior to its installation in the substrate. The particular substrate 12 is of copper or a copper alloy, while the billet 14 is of silver. Silver is more corrosion resistant than copper and has a lower electrical resistance, so it provides a desirable surface that another contact can move against, as when a switch is closed, to provide a low resistance connection between the billet and second contact. The particular substrate includes a platform 20 with a recess 22 that holds the billet, and with a peg 24 that can be inserted into a device that is to be electrically connected to the billet.

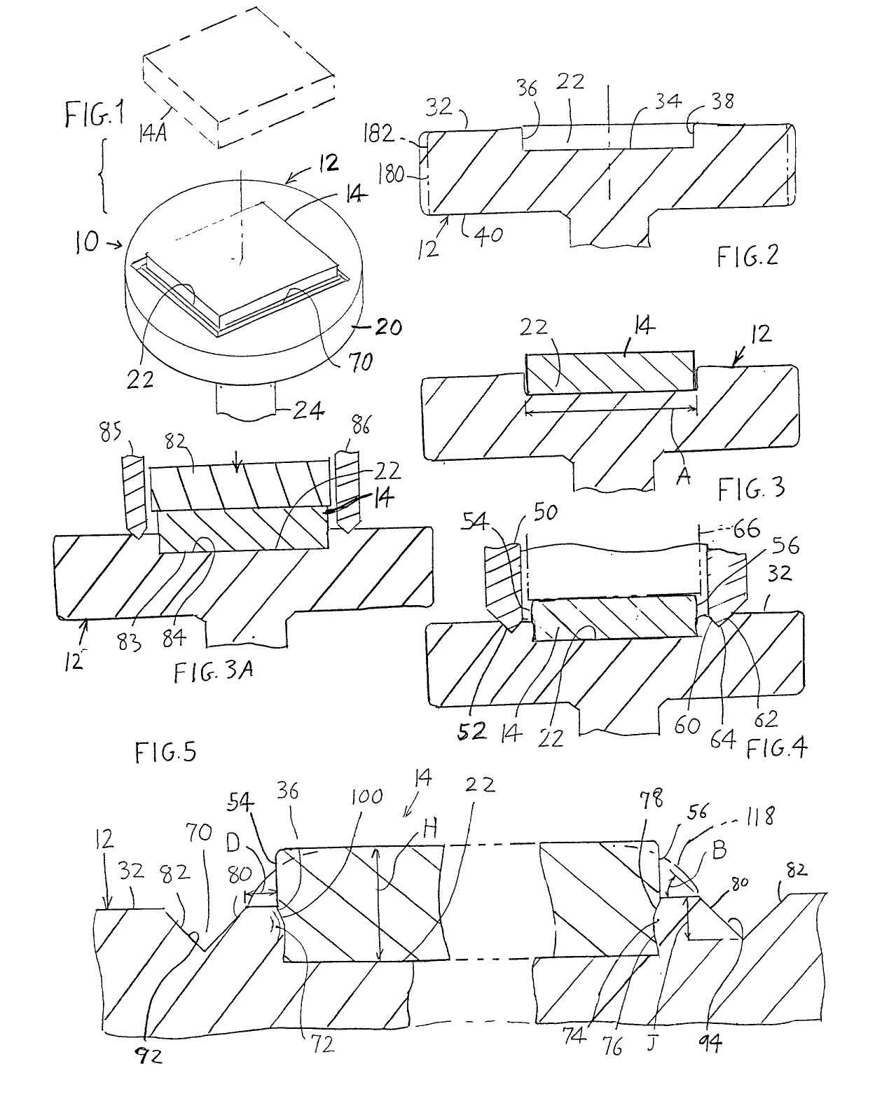

FIG. 2 shows a first step in the installation of the billet, which includes forming the recess 22 in the upper face 32 of the substrate. The particular recess 22 is a blind recess with the substrate forming a bottom wall 34 of the recess, as well as the recess sides such as 36, 38. The depth of the recess is preferably no more than half the substrate thickness between its upper and lower faces 22, 40. This enables the recess to be formed by pressing down a first punch with only a moderate force.

FIG. 3 shows a second step of the process, which includes moving the metal billet 14 down into the recess 22. The recess may have a width A such as 80 mils (one mil equals one thousandth inch), or 2 mm, while the billet may have a width that is perhaps 4 mils less than that of the recess, so the billet is easily moved down into the recess with little or no interference. A possible next step is to lightly (e.g. 100 pounds) hold the billet in a full downward position in the recess, which prevents the recess from moving up or tilting when jolted or vibrated. Steps for lightly holding the billet in the recess are described below.

FIG. 4 shows a next step in the process, for securely holding the billet in the recess, which includes lowering a second punch 50 so it moves down into the upper face 32 of the substrate. The lower end 52 of the punch displaces metal of the substrate, with some of the displaced substrate metal moving into opposite sides 54, 56 of the billet, and thereby holding the billet in the substrate. The second punch has four sides that displace substrate material against all four sides of the rectangular billet.

The lower end 52 of the second punch is V-shaped, with one side 60 which is closest to an adjacent side of the recess, extending at an incline to the horizontal, and in a direction downwardly and away from the recess. This side or wall of the punch lower end, results in it partially facing the recess and thereby pushing displaced substrate material towards the recess and therefore towards a side of the billet. The opposite wall 62 of the second punch lower end, could be constructed so it extends vertically from the tip 64, but applicant prefers to have it extend at an upward incline away from the recess. The incline angle of wall 62 is preferably about the same (within 20°) of the incline of the wall 60. This results in equal forces in opposite directions to avoid sideward shifting of the punch that could break it. The punches are of harder material than the substrate material, with a carbide punch being preferred.

Applicant prefers to use a pressure plate 66 to hold down the billet before the punches 50 start to form their grooves 52, and to continue to hold down the billet until the punches stop their downward movement. Such pressure plate is mounted on a spring and presses down with a force such as 100 pounds.

FIG. 5 shows details of each side of the billet in the completed contact assembly. The substrate 12 has depressions 92, 94 forming a groove 70 and has a quantity 72, 74 of pressure-flowed substrate metal at each side of the recess. Each quantity 72, 74 presses into a side 54, 56 of the billet to lock the billet in the recess 22. The result of the quantities 72, 74 of pressure-flowed substrate metal, results in an undercut 76 in the walls of the recess and in corresponding billet shoulders 78 that lock the billet 14 in place. If a specimen is cut to form a cross section of the type shown in FIG. 5, the fact that the quantities 72, 74 of substrate material were pressure-flowed can be readily observed under microscopic analysis. The groove or depression 70 in the substrate upper face 32 has opposite sides 80, 82, with the side 80 closest to the billet being responsible for displacing of substrate material such as 72 into the billet to lock it in place.

Applicant prefers that the side 80 extend at an angle B to the horizontal of about 45°, and extend downwardly and away from the billet. The angle B should be between 20° and 70° in order to displace considerable substrate material into the billet side. There is a small distance D between the top of the depression and the recess, which results in sufficient thickness between the depression side 80 and the recess side 36 to prevent that material from deflecting under the forces encountered in normal use. The distance D is preferably no more than twice the depth J of the groove, and preferably no more than the depth of the groove, to enable substrate material to press firmly into the billet and lock it in place.

FIG. 3A shows a processing step which is not always necessary, to lightly hold the billet in the recess until it can be securely held in the step of FIG. 4. The step of FIG. 3A follows the step of FIG. 3 where the billet 14 has been placed in the recess 22. In FIG. 3A, a pressure plate 82 is pressed down with a spring force of at least about 100 pounds to press the bottom 83 of the billet and recess bottom wall 84 into intimate contact with each other. This assures low electrical resistance between them. Then, a pair of punch parts 85, 86 press into the substrate by about half the depth of the final groove. The punch parts displace substrate material so the billet is lightly held in place until the next step shown in FIG. 4.

Instead of using the punch parts 85, 86, it is possible to press down the billet in FIG. 3A with a high force, to obtain the Poisson effect of horizontal expansion as a result of vertical compression. For the parallelopiped billet shown, which has a horizontal width of 76 mils and a horizontal length of 96 mils, applicant applies a force of about 650 pounds. This force, which results in a pressure of about 85,000 psi, compresses the billet from 22.5 mils to 20.5 mils and increase the width and length each by about 5 mils (or until the billet presses against opposite sides and/or ends of the recess walls). This results in the billet expanding against the walls of the recess to hold the billet in place with a moderate force which may be sufficient in some cases. For silver and most of its highly conductive alloys, a downward pressure of about 85,000 psi (30,000 to 250,000 psi) creates sufficient horizontal expansion to press-fit the billet in the recess, where the billet already fits closely (within about 8 mils) but with slight clearance. The same pressure will deform billets of most metals that are softer than iron, so a billet of a width up to one inch will expand by two to eight mils. It is possible for a microscopic examination of a cross-section of the substrate with the compressed and horizontally expanded billet in the recess, to determine that the billet was compressed in the recess, especially by examination of the bottom wall of the recess.

It is possible to lock a billet in the recess with only two or three depressions and consequent pressure-flowed quantities of substrate material, instead of the four depressions 92-98 of FIG. 7 that extend 360° around the billet. If the billet is round as seen in a top view, and three depressions are used which are spaced 120° apart about the billet, then any two depressions can be said to lie on opposite sides of the billet. However, instead of using two or four depressions for the rectangular billet of FIGS. 1-7, applicant provides one continuous depression or groove 70 that extends completely around the recess without interruption, or in other words 360° about the axis 90 of the recess and billet. FIG. 7 shows that the groove 70 has four groove portions 92, 94, 96, 98 which form a continuous groove that is preferably uniformly spaced from the recess 22. The advantage of this is in forming a fluid-tight seal at 100 (FIG. 5) between the substrate and billet. In some applications, as where the billet lies on electronic equipment that must be plated after the billet is installed, and where the billet itself may or may not be plated, an unsealed billet could allow plating solution to leak into the recess. Such leaked plating solution could cause corrosion between the billet and the sides of the recess, resulting in increased resistance thereat. It is noted that in use in a switch, one contact of the switch usually permanently engages the substrate while another contact intermittently engages the billet, and current flows between the billet and substrate. Applicant's continuous depression or groove that results in fluid-tight sealing, avoids corrosion that would increase the substrate-billet electrical resistance.

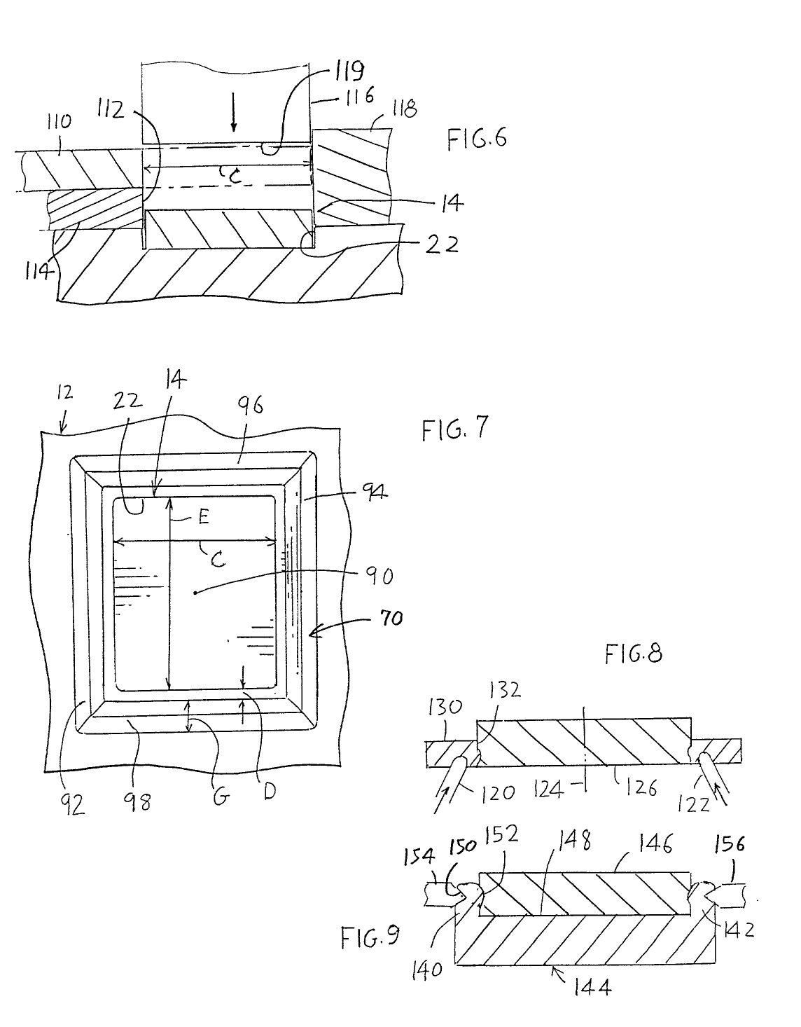

FIG. 6 shows how a billet is formed from an elongated continuous strip 110 of billet material such as silver, and how the billet is moved down into the recess 22. The strip is advanced horizontally by the distance C equal to the width of the billet, so the strip length overhangs an end 112 of a carbide cutting die 114. Then, a shearing member 116 is moved down to shear the length C of strip material and press it down into the recess. A stop and guide 118 helps avoid tilt of the billet. It is possible for the lower face 119 of the shearing member to push down the billet with sufficient force (e.g. about 85,000 psi) to expand the billet so it is held in place.

In a contact assembly of the construction shown in FIGS. 1-7 that applicant has designed, the billet had a width C (FIG. 7) of 76 mils (0.076 inch) and a length E of 96 mils. The billet had an initial height of 22.5 mils, which was compressed to a height H (FIG. 5) of 20.5 mils by the pressure plate of FIG. 3A. About 10 mils of billet depth projected above the substrate upper face. The groove 70 had a depth J of 7 mils and a width G (FIG. 7) of 14 mils, with the top of the groove spaced a distance D of 3 mils from the top of the recess. Each side of the groove extended at an angle B (FIG. 5) of 45° to the horizontal. Applicant prefers that the side 80 closest to the recess extend at an angle of at least 30° to the horizontal to push considerable substrate material against the billet. It is possible to form the billet with rounded edges, as shown at 118 in FIG. 5, as by a corresponding part of the second die or with a pressure plate.

FIG. 8 illustrates another embodiment of the invention, where a pair of punches 120, 122 each press at an angle to the axis 124 of a billet 126, to displace material of the substrate 130 towards the recess 132. While such movement of punches towards the billet helps displace material into the billet, the need to move the punches at an angle to the axis 124 increases the cost for manufacture.

FIG. 9 illustrates another embodiment of the invention, where the side walls 140, 142 of a recess 148 in a substrate 144 which surrounds a billet 146, have a thickness of the same order of magnitude as the depth of the recess. In this case, punches 154, 156 are pressed primarily horizontally into opposite sides of the substrate to form deformations 150 that result in flowed substrate material 152 that locks the billet in the substrate recess. The downward movement of a second punch, as in FIG. 4, is generally accomplished at a lower cost.

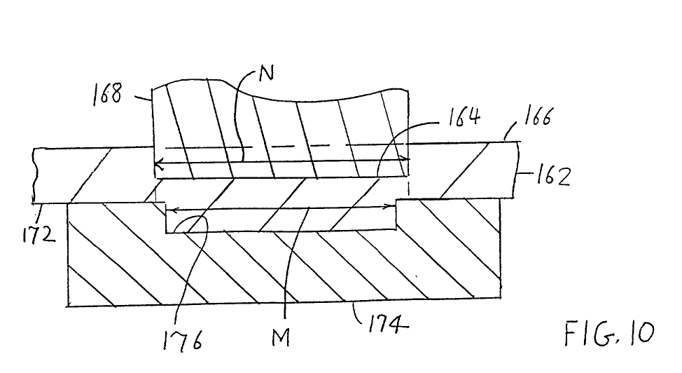

FIG. 10 illustrates a first step in construction of another contact assembly that includes an initially plate-shaped substrate 162 with a recess 164 formed in its upper surface 166 by a punch 168. The plate 162 has a width and length that are each more than three times the width and length of the recess. The punch has a width of 80 mils (0.080 inch). The bottom surface 172 of the substrate is backed by a die 174 having a cavity 176 directly below the recess. The width of the cavity is 74 mils. This avoids fracture of the substrate. The substrate has a plurality of recess which will each be filled with a billet. It requires a force of a few tons on the punch, to form the recess. When the recess is formed, a downward protrusion 178 is formed in the lower face of the plate. This provides a region to receive displaced substrate material. This greatly reduces the required force on the punch (e.g. from 10 tons to 3 tons), reduces wear on the punch, and avoids fracturing and subsequent weakening of the substrate material. The fact that the width M of the cavity 176 is less than the width N of the punch results in avoiding fracturing and subsequent weakening of the substrate material. It is noted that in FIG. 2, where the platform diameter was 0.220 inch, applicant supported the entire bottom of the platform around the peg. The diameter of the platform grew from 0.220 inch to 0.226 inch to absorb the displaced material. Such growth cannot be relied upon to receive displaced material for a plate of large width and length.

While actual metal is usually preferred for the substrate and billet, new plastic materials are being developed which can flow like metals, and are therefore the equivalent of metals in the present invention. In some cases, a nickel foil is placed at the bottom of the billet, to avoid migration of copper material into the silver billet.

While terms such as “upper” and “lower” have been used to describe the contact assembly, it should be understood that the contact assembly can be used in any orientation with respect to the Earth. While a billet of rectangular shape, as seen in a plan view, is illustrated, it should be noted that the billet can be of any shape. Also, the billet need not project above the adjacent upper face portion of the substrate, but can lie flush or slightly depressed from the substrate upper face.

Thus, the invention provides a contact assembly that includes a billet of one metal lying in a recess of a different substrate metal, where the contact assembly can be constructed at low cost. The substrate has a depression in each of its opposite sides, and has pressure-flowed quantities of substrate metal opposite each depression, with each quantity projecting into a deformed billet side to lock the billet in the recess. The depression has a side adjacent to the recess, that extends downwardly and away from the recess. Depressions preferably extend around the recess in a continuous 360° groove around the entire recess, to seal the billet to the walls of the recess. The groove can be formed by moving a punch downwardly into an upper face of the substrate. The billet preferably has a width and length that are each more than its thickness, and preferably more than twice its thickness. This reduces the amount of required silver and thickness of the substrate. The thermal coefficient of expansion of silver (19×10⁻⁶/° C.) is greater than that of copper (16.6×10⁻⁶/° C.). However, even if the plate-like billet bows up, its circumference retains good contact with the substrate. The billet can be press-fitted into the recess by pressing down a close fitting billet with a pressure of about 85,000 psi to expand its width and length by more than 1 mil in each direction to expand it against the walls of the recess.

Although particular embodiments of the invention have been described and illustrated herein, it is recognized that modifications and variations may readily occur to those skilled in the art, and consequently, it is intended that the claims be interpreted to cover such modifications and equivalents.

What is claimed is

1. A contact assembly that includes a substrate with upper and lower faces and a recess extending into at least said upper face, and a metal billet with a lower portion lying closely in said recess, wherein:
said recess has horizontally spaced opposite recess sides and said billet has horizontally spaced opposite billet sides, with each side of said billet lying adjacent to a side of said recess, and said substrate has a depression in each of said sides of said substrate, with each depression projecting into said substrate and resulting in a pressure-flowed quantity of substrate metal that projects into one of said billet sides to lock the billet in the recess.

2. The contact assembly described in claim 1 wherein:
said depressions are formed in said substrate upper face, and each depression has a side lying nearest the recess and extending at a downward incline and away from the recess.

3. The contact assembly described in claim 2 wherein:
each side of said depressions that lies nearest the recess, extends at an angle of 20° to 70° from the substrate upper face.

4. The contact assembly described in claim 1 wherein:
said recess has a circumference;
said depressions are part of a continuous groove that extends completely around said circumference of said recess.

5. The contact assembly described in claim 4 wherein:
said recess is a blind recess that extends downward only part of the way through said substrate.

6. The contact assembly described in claim 1 wherein:
said substrate is formed primarily of copper and said billet is formed primarily of silver, to thereby provide an electrical contact of low resistant and good corrosion resistance.

7. A contact assembly comprising:
a metal substrate having an upper face and having a recess in said upper face;
a metal billet having a lower portion lying in said recess;
a plurality of depression portions in said substrate upper face, with said depression portions being spaced about said recess, said depression portions each having a wall closest to said recess which is inclined downwardly and away from said recess.

8. The contact assembly described in claim 7 wherein:
said recess has a vertical axis and said depression portions are part of a continuous groove that extends 360° around said axis.

9. The contact assembly described in claim 7 wherein:
said depression portions each have a wall furthest from said recess which is inclined upwardly and away from said recess.

10. A contact assembly that includes a substrate with upper and lower faces and a billet of high conductivity metal fixed to said substrate, wherein:
said substrate has a recess extending into said substrate upper face, and said billet has at least a billet lower portion lying in said recess in an interference fit with walls of said recess;
said billet has a width and length that each extends horizontally when said substrate upper face is horizontal, and said billet has a vertical thickness which is less than said width and that is less than said length.

11. The contact assembly described in claim 10 wherein:
said thickness of said billet is less than half the billet width and less than half the billet length.

12. The contact assembly described in claim 10 wherein:
said recess extends only partially through said substrate, with said recess having a recess bottom wall at the bottom of said recess;
said billet has a billet bottom wall that lies facewise against said recess bottom wall.

13. The contact assembly described in claim 10 wherein:
said recess has opposite recess walls that are undercut so said recess walls form partially downwardly-facing shoulders, and said billet has opposite billet walls that conform to said opposite recess walls to form partially upwardly-facing shoulders that prevent upward billet movement, to thereby lock a thin billet in said recess.

14. The contact assembly described in claim 10 wherein:
said upper face has opposite locations on opposite sides of said recess, with depressions in said locations, with each depression having a wall that extends at an upward incline toward said recess and with each of said walls spaced from said recess by no more than the depth of the recess.

15. A method for constructing an electrical contact assembly by installing a billet of predetermined width and which is formed of high conductivity metal, in a substrate that has an upper face, so the billet forms an electrical contact, comprising:
forming a recess in the upper face of said substrate, where the recess has substantially the same width as said billet and said recess has opposite sides, and inserting said billet into said recess;
applying pressure to said substrate at substrate locations that lie beyond said opposite sides of said recess, to deform substrate material at said locations into said sides of said billet, to thereby lock said billet in said recess.

16. The method described in claim 15 wherein:
said step of applying pressure includes pressing a pair of punch parts downwardly against the upper face of the substrate, at locations lying beyond said opposite sides of said recess.

17. The method described in claim 15 wherein:
said step of applying pressure includes downwardly pressing a plurality of punch portions into substrate locations in said substrate upper face, to form substrate depression portions that each are of a predetermined depth and that are each spaced from the recess by no more than the depth of the depression portions.

18. The method described in claim 15 wherein:
said step of inserting said billet includes pressing down said billet and deforming said substrate at opposite sides of said billet while said billet is pressed down.

19. A method for constructing an electrical assembly by installing high conductivity metal that is softer than iron, in a recess of a substrate that has an upper face, so the billet forms an electrical contact, where the recess has a predetermined width of no more than one inch, comprising:
forming a billet which has a width between one and eight thousandths inch less than the width of said recess;
sliding a billet of said high conductivity metal down into said recess in said substrate, and pressing down against an upper face of said billet with a pressure of about 85,000 psi to expand the width of said billet so opposite sides of said billet press firmly against opposite sides of said recess to hold the billet in the recess.

20. The method described in claim 19 wherein said substrate is of metal, including:
applying force to said substrate at locations around said recess to deform said locations and press substrate material into said sides of said recess to lock the billet in the recess.

21. The method described in claim 19 wherein:
said substrate is a copper alloy and said billet is a silver alloy.

22. A contact assembly that includes a substrate with upper and lower faces and a recess extending into at least said upper face, and a metal billet of highly electrically conductive material with said billet having a lower portion lying in said recess, wherein:
said recess has horizontally spaced opposite recess sides and said billet has horizontally spaced opposite billet sides that lie tightly against said recess sides.

23. The contact assembly described in claim 22 wherein:
said billet is compressed in height in said recess, sufficiently to expand it against said recess sides.

24. The contact assembly described in claim 22 wherein:
said recess has a width and length and said substrate is a plate having a width and length that are each at least three times the width and length of said recess, and said plate has a downwardly-extending projection that extends from a lower face of said plate under said recess, with said projection having a projection width less than the width of said recess but at least half as great.
